(19) United States
(12) Patent Application Publication
(10) Pub. No.: US 2026/0285202 A1
(43) Pub. Date: Sep. 24, 2026

(54) CONTROL SYSTEM AND METHOD FOR VEHICLE TRUNK

(71) Applicants: Hyundai Motor Company, Seoul (KR); Kia Corporation, Seoul (KR)

(72) Inventor: Guang You Dong, Yantai (CN)

(21) Appl. No.: 19/570,971

(22) Filed: Mar. 18, 2026

(30) Foreign Application Priority Data
Mar. 19, 2025 (CN) 202510325807.0

(51) Int. Cl. B60N 2/02; B60N 2/00; B60N 2/01; B60N 2/20; B60Q 9/00; B60R 5/04; B60R 16/037; G10L 15/22

(52) U.S. Cl. CPC B60N 2/0279; B60N 2/0021; B60N 2/01; B60N 2/206; B60Q 9/00; B60R 5/045; B60R 16/0373; G10L 15/22; G10L 2015/223

(57) ABSTRACT

A control system and method for a vehicle trunk are disclosed. The control system may comprise a sensing device configured to detect a height or a volume of a cargo carried by a user; a seat control device configured to fold a second-row seat and/or a third-row seat; and a main control device communicatively connected to the sensing device and the seat control device, respectively, wherein the main control device is configured to receive the height or the volume of the cargo carried by the user from the sensing device when a tailgate of a vehicle is in an openable state, and to operate the seat control device based on the height or the volume of the cargo carried by the user.

### CROSS-REFERENCE TO RELATED APPLICATION(S)

This application claims, under 35 U.S.C. § 119(a), the benefit of Chinese Patent Application No. 202510325807.0, filed Mar. 19, 2025, the entire contents of which are incorporated herein by reference.

### BACKGROUND

### (a) Technical Field

The present disclosure relates to a field of vehicle control technology and, more particularly, to a control system and method for a vehicle trunk.

### (b) Background

During daily vehicle use, users frequently encounter situations in which they must load cargo of various volumes. When a user needs to load relatively large cargo, rear seats generally must be manually adjusted to secure more loading space. However, when the user is already holding cargo, such manual seat adjustment becomes very difficult and inconvenient. To resolve this problem, implementing an automatic folding function for seats may be considered. For example, by introducing a more intelligent or automated solution to easily fold rear seats, the burden on the user when loading large-sized cargo may be significantly reduced.

Additionally, some vehicle models are already equipped with a two-stage luggage board to provide more flexible loading options. However, when a relatively heavy object must be placed on an upper cover plate of the trunk, the height of the upper cover plate may impose an additional physical burden on the user. Therefore, it is particularly important to design a mechanism capable of adjusting the height of the upper cover plate according to a height of the user. Such a design not only ensures that all users may comfortably load and unload cargo but also effectively prevents safety issues caused by improper manipulation.

Accordingly, there is a need for more intelligent and user-friendly design improvements to significantly enhance the convenience and user experience of using a vehicle trunk.

The above information disclosed in this Background section is only for enhancement of understanding of the background of the present disclosure, and therefore it may contain information that does not form the prior art that is already known in this country to a person of ordinary skill in the art.

### SUMMARY

An exemplary embodiment of the present disclosure attempts to provide a control system and a method for a vehicle trunk that, when a user approaches a tailgate of a vehicle while carrying cargo, adjusts a height of a trunk upper cover plate, causes the trunk upper cover plate to be folded, and causes second-row seats and/or third-row seats to be folded by detecting the user's height, a height or volume of the cargo carried by the user, and the number of passengers on the seats. Accordingly, cargo of various sizes may be loaded, and the needs of users of various heights may be met.

According to an exemplary embodiment of the present disclosure, a control system for a vehicle trunk is provided. The control system may comprise a sensing device configured to detect a height or a volume of a cargo carried by a user; a seat control device configured to fold a second-row seat and/or a third-row seat; and a main control device communicatively connected to the sensing device and the seat control device, respectively, wherein the main control device is configured to receive the height or the volume of the cargo carried by the user from the sensing device when a tailgate of a vehicle is in an openable state, and to operate the seat control device based on the height or the volume of the cargo carried by the user.

The control system for the vehicle trunk may further comprise an in-vehicle passenger detection device communicatively connected to the main control device and configured to detect a number of passengers and a seating position on the second-row seat and/or the third-row seat. The main control device may be further configured to: determine whether the height of the cargo carried by the user is less than or equal to a height of the trunk and whether the volume of the cargo carried by the user is less than or equal to a capacity of the trunk in a normal state; determine, when it is determined that the height of the cargo carried by the user is less than or equal to the height of the trunk or the volume of the cargo carried by the user is less than or equal to the capacity of the trunk in the normal state, whether the height of the cargo carried by the user is greater than the height of the trunk and less than or equal to a depth of the trunk after folding of the third-row seat, or whether the volume of the cargo carried by the user is greater than the capacity of the trunk in the normal state and less than or equal to the capacity of the trunk after folding of the third-row seat; obtain the number of passengers and the seating position on the third-row seat when it is determined that the height of the cargo carried by the user is greater than the height of the trunk and less than or equal to the depth of the trunk after folding of the third-row seat, or that the volume of the cargo carried by the user is greater than the capacity of the trunk in the normal state and less than or equal to the capacity of the trunk after folding of the third-row seat; and fold a seat, among the third-row seats, on which a passenger is not seated according to the seating position on the third-row seat.

The control system for the vehicle trunk may further comprise an upper cover plate control device communicatively connected to the main control device and configured to adjust a height of an upper cover plate. The sensing device may be further configured to detect a height of the user. The main control device may be further configured to: determine whether the height of the cargo carried by the user is less than or equal to a height of an upper portion of the trunk and whether the volume of the cargo carried by the user is less than or equal to a capacity of the upper portion of the trunk; and adjust the height of the upper cover plate according to the height of the user when it is determined that the height of the cargo carried by the user is less than or equal to the height of the upper portion of the trunk and the volume of the cargo carried by the user is less than or equal to the capacity of the upper portion of the trunk.

The main control device may be further configured to: retrieve a corresponding adjustment height of the upper cover plate according to the height of the user in a predetermined mapping table; adjust the height of the upper cover plate to a sum of a basic height and the adjustment height according to the retrieved adjustment height of the upper cover plate; and restore the upper cover plate to the basic height after a predetermined period of time has elapsed. The predetermined mapping table may store a correspondence relationship between the height of the user and the adjustment height of the upper cover plate.

The control system for the vehicle trunk may further comprise an upper cover plate control device communicatively connected to the main control device and configured to fold an upper cover plate. The main control device may be further configured to: determine whether the height of the cargo carried by the user is greater than a height of an upper portion of the trunk and less than or equal to a height of a lower portion of the trunk, and whether the volume of the cargo carried by the user is greater than a capacity of the upper portion of the trunk and less than or equal to a capacity of the lower portion of the trunk; determine, when it is determined that the height of the cargo carried by the user is greater than the height of the upper portion of the trunk and less than or equal to the height of the lower portion of the trunk, or that the volume of the cargo carried by the user is greater than the capacity of the upper portion of the trunk and less than or equal to the capacity of the lower portion of the trunk, whether the height of the cargo carried by the user is greater than the height of the lower portion of the trunk and less than or equal to a sum of the height of the lower portion and the height of the upper portion of the trunk, and whether the volume of the cargo carried by the user is greater than the capacity of the lower portion of the trunk and less than or equal to a sum of the capacity of the upper portion and the capacity of the lower portion of the trunk; and fold the upper cover plate when it is determined that the height of the cargo carried by the user is greater than the height of the lower portion of the trunk and less than or equal to the sum of the height of the lower portion and the height of the upper portion of the trunk, or that the volume of the cargo carried by the user is greater than the capacity of the lower portion of the trunk and less than or equal to the sum of the capacity of the upper portion and the capacity of the lower portion of the trunk.

The control system for the vehicle trunk may further comprise an in-vehicle passenger detection device communicatively connected to the main control device and configured to detect a number of passengers and a seating position on the second-row seat and/or the third-row seat. The main control device may be further configured to: determine whether the height of the cargo carried by the user is greater than the sum of the height of the lower portion and the height of an upper portion of the trunk and less than or equal to a depth of the trunk after folding of the third-row seat, or whether the volume of the cargo carried by the user is greater than the sum of the capacity of the upper portion and the capacity of the lower portion of the trunk and less than or equal to a capacity of the trunk after folding of the third-row seat; and obtain the number of passengers and the seating position on the third-row seat when it is determined that the height of the cargo carried by the user is greater than the sum of the height of the lower portion and the height of the upper portion of the trunk and less than or equal to the depth of the trunk after folding of the third-row seat, or that the volume of the cargo carried by the user is greater than the sum of the capacity of the upper portion and the capacity of the lower portion of the trunk and less than or equal to the capacity of the trunk after folding of the third-row seat.

The main control device may be further configured to and fold a seat, among the third-row seats, on which a passenger is not seated according to the seating position on the third-row seat.

The main control device may be further configured to: in a state in which all third-row seats are folded, determine whether the height of the cargo carried by the user is greater than the depth of the trunk after folding of the third-row seat, or whether the volume of the cargo carried by the user is greater than the capacity of the trunk after folding of the third-row seat; and obtain the number of passengers and a seating position on the second-row seat when it is determined that the height of the cargo carried by the user is greater than the depth of the trunk after folding of the third-row seat, or that the volume of the cargo carried by the user is greater than the capacity of the trunk after folding of the third-row seat.

The main control device may be further configured to fold a second-row seat on which a passenger is not seated according to the seating position on the second-row seat.

The main control device may be further configured to: in a state in which the seat among the third-row seats on which a passenger is not seated is folded, determine whether the height of the cargo carried by the user is greater than the depth of the trunk after folding of the third-row seat, or whether the volume of the cargo carried by the user is greater than the capacity of the trunk after folding of the third-row seat; determine, when it is determined that the height of the cargo carried by the user is greater than the depth of the trunk after folding of the third-row seat, or that the volume of the cargo carried is greater than the capacity of the trunk after folding of the third-row seat, whether a passenger is present at a position in the second-row seat corresponding to the folded seat of the third-row seat; and fold a seat at the position in the second-row seat corresponding to the folded seat of the third-row seat when it is determined that no passenger is present at the position in the second-row seat corresponding to the folded seat of the third-row seat.

The control system for the vehicle trunk may further comprise a voice recognition device communicatively connected to the main control device and configured to obtain a voice signal of the user, convert the voice signal of the user into a user request signal, and transmit the user request signal to the main control device. The main control device may be further configured to receive the user request signal from the voice recognition device when it is determined that the tailgate of the vehicle is in an openable state, operate the upper cover plate control device and/or the seat control device according to the user request signal to adjust a height of the upper cover plate, fold the upper cover plate, and fold the second-row seat and/or the third-row seat.

The control system for the vehicle trunk may further comprise a display device and an audio output device communicatively connected respectively to the main control device. The display device may be configured to pop up a notification message prompting the user to take out the cargo from the trunk when an ignition of the vehicle is turned off; or the audio output device may be configured to output a warning sound prompting the user to take out the cargo from the trunk when the vehicle is turned off.

Another embodiment of the present disclosure provides a control method for a vehicle trunk. The control method for the vehicle trunk may comprise: detecting, by a sensing device, a height or a volume of a cargo carried by a user; obtaining, by a main control device, the height or the volume of the cargo carried by the user when a tailgate of a vehicle is in an openable state; and controlling, by a seat control device, a second-row seat and/or a third-row seat to be folded based on the obtained height or the obtained volume.

The control method for the vehicle trunk may further comprise determining whether the height of the cargo carried by the user is less than or equal to a height of the trunk and whether the volume of the cargo carried by the user is less than or equal to a capacity of the trunk in a normal state; determining, when it is determined that the height of the cargo carried by the user is less than or equal to the height of the trunk or the volume of the cargo carried by the user is less than or equal to the capacity of the trunk in the normal state, whether the height of the cargo carried by the user is greater than the height of the trunk and less than or equal to a depth of the trunk after folding of the third-row seat, or whether the volume of the cargo carried by the user is greater than the capacity of the trunk in the normal state and less than or equal to the capacity of the trunk after folding of the third-row seat; detecting, by an in-vehicle passenger detection device, a number of passengers and a seating position on the third-row seat when it is determined that the height of the cargo carried by the user is greater than the height of the trunk and less than or equal to the depth of the trunk after folding of the third-row seat, or that the volume of the cargo carried by the user is greater than the capacity of the trunk in the normal state and less than or equal to the capacity of the trunk after folding of the third-row seat; folding a seat, among the third-row seats, on which a passenger is not seated according to the seating position on the third-row seat.

The control method for the vehicle trunk may further comprise detecting, by the sensing device, a height of the user; determining, by the main control device, whether the height of the cargo carried by the user is less than or equal to a height of an upper portion of the trunk and whether the volume of the cargo carried by the user is less than or equal to a capacity of the upper portion of the trunk; and adjusting, by the main control device, the height of the upper cover plate according to the height of the user when it is determined that the height of the cargo carried by the user is less than or equal to the height of the upper portion of the trunk and the volume of the cargo carried by the user is less than or equal to the capacity of the upper portion of the trunk.

The control method for the vehicle trunk may further comprise retrieving a corresponding adjustment height of the upper cover plate according to the height of the user in a predetermined mapping table; adjusting the height of the upper cover plate to a sum of a basic height and the adjustment height according to the retrieved adjustment height of the upper cover plate; and restoring the upper cover plate to the basic height after a predetermined period of time has elapsed. The predetermined mapping table may store a correspondence relationship between the height of the user and the adjustment height of the upper cover plate.

The control method for the vehicle trunk may further comprise determining, by the main control device, whether the height of the cargo carried by the user is greater than a height of an upper portion of the trunk and less than or equal to a height of a lower portion of the trunk, and whether the volume of the cargo carried by the user is greater than a capacity of the upper portion of the trunk and less than or equal to a capacity of the lower portion of the trunk; determining, by the main control device, when it is determined that the height of the cargo carried by the user is greater than the height of the upper portion of the trunk and less than or equal to the height of the lower portion of the trunk, or that the volume of the cargo carried by the user is greater than the capacity of the upper portion of the trunk and less than or equal to the capacity of the lower portion of the trunk, whether the height of the cargo carried by the user is greater than the height of the lower portion of the trunk and less than or equal to a sum of the height of the lower portion and the height of the upper portion of the trunk, and whether the volume of the cargo carried by the user is greater than the capacity of the lower portion of the trunk and less than or equal to a sum of the capacity of the upper portion and the capacity of the lower portion of the trunk; and folding, by an upper cover plate control device, the upper cover plate when it is determined that the height of the cargo carried by the user is greater than the height of the lower portion of the trunk and less than or equal to the sum of the height of the lower portion and the height of the upper portion of the trunk, or that the volume of the cargo carried by the user is greater than the capacity of the lower portion of the trunk and less than or equal to the sum of the capacity of the upper portion and the capacity of the lower portion of the trunk.

The control method for the vehicle trunk may further comprise determining, by the main control device, whether the height of the cargo carried by the user is greater than the sum of the height of the lower portion and the height of the upper portion of the trunk and less than or equal to a depth of the trunk after folding of the third-row seat, or whether the volume of the cargo carried by the user is greater than the sum of the capacity of the upper portion and the capacity of the lower portion of the trunk and less than or equal to a capacity of the trunk after folding of the third-row seat; and detecting, by an in-vehicle passenger detection device, a number of passengers and a seating position on the third-row seat when it is determined that the height of the cargo carried by the user is greater than the sum of the height of the lower portion and the height of the upper portion of the trunk and less than or equal to the depth of the trunk after folding of the third-row seat, or that the volume of the cargo carried by the user is greater than the sum of the capacity of the upper portion and the capacity of the lower portion of the trunk and less than or equal to the capacity of the trunk after folding of the third-row seat.

The control method for the vehicle trunk may further comprise folding a seat, among the third-row seats, on which a passenger is not seated according to the seating position on the third-row seat.

The control method for the vehicle trunk may further comprise, in a state in which all third-row seats are folded, determining whether the height of the cargo carried by the user is greater than the depth of the trunk after folding of the third-row seat, or whether the volume of the cargo carried by the user is greater than the capacity of the trunk after folding of the third-row seat; and detecting, by an in-vehicle passenger detection device, a number of passengers and a seating position on the second-row seat when it is determined that the height of the cargo carried by the user is greater than the depth of the trunk after folding of the third-row seat, or that the volume of the cargo carried by the user is greater than the capacity of the trunk after folding of the third-row seat.

The control method for the vehicle trunk may further comprise folding a second-row seat on which a passenger is not seated according to the seating position on the second-row seat.

The control method for the vehicle trunk may further comprise, in a state in which the seat among the third-row seats on which a passenger is not seated is folded, determining whether the height of the cargo carried by the user is greater than the depth of the trunk after folding of the third-row seat, or whether the volume of the cargo carried by the user is greater than the capacity of the trunk after folding of the third-row seat; determining, when it is determined that the height of the cargo carried by the user is greater than the depth of the trunk after folding of the third-row seat, or that the volume of the cargo carried is greater than the capacity of the trunk after folding of the third-row seat, whether a passenger is present at a position in the second-row seat corresponding to the folded seat of the third-row seat; and folding a seat at the position in the second-row seat corresponding to the folded seat of the third-row seat when it is determined that no passenger is present at the position in the second-row seat corresponding to the folded seat of the third-row seat.

The control method for the vehicle trunk may further comprise obtaining, by a voice recognition device, a voice signal of the user and converting the voice signal of the user into a user request signal; and obtaining, by the main control device, the user request signal when it is determined that the tailgate of the vehicle is in an openable state, and operating the upper cover plate control device and/or the seat control device according to the user request signal to adjust a height of the upper cover plate, folding the upper cover plate, and folding the second-row seat and/or the third-row seat.

The control method for the vehicle trunk may further comprise popping up, by a display device, a notification message prompting the user to take out the cargo from the trunk when an ignition of the vehicle is turned off; or outputting, by an audio output device, a warning sound prompting the user to take out the cargo from the trunk when the ignition of the vehicle is turned off.

According to an exemplary embodiment of the present disclosure, a height or a volume of a cargo carried by a user may be determined through a sensing device to control operations (for example, folding) of a second-row seat and/or a third-row seat. When the user needs to load cargo having a relatively large volume, the system may automatically fold or move the seats to secure more loading space and simplify the operation process.

According to an exemplary embodiment of the present disclosure, a height of the user may be determined through the sensing device, and a height of an upper cover plate may be adjusted according to the height of the user and the volume of the cargo carried by the user, thereby allowing the user to more comfortably and conveniently load or unload the cargo.

According to an exemplary embodiment of the present disclosure, a voice control function is supported, so that the user may control folding or moving of the second-row seat and/or the third-row seat, folding of the upper cover plate, and the height of the upper cover plate, through only a simple voice command. Accordingly, not only can the user use his or her hands freely, but the efficiency and safety of the operation can also be improved.

In conclusion, according to an exemplary embodiment of the present disclosure, it is possible to provide a more convenient and comfortable usage experience to the user while improving the practicality and marketability of the vehicle.

In addition, effects that may be obtained or expected from embodiments of the present disclosure are directly or suggestively described in the following detailed description. That is, various effects expected from embodiments of the present disclosure will be described in the following detailed description.

### BRIEF DESCRIPTION OF THE DRAWINGS

The foregoing and other aspects, as well as the following detailed description of the embodiments, should be better understood when read in conjunction with the accompanying drawings. However, the present disclosure is not intended to be limited to the details shown in the drawings, and various modifications and structural changes may be made therein without departing from the spirit of the present disclosure and within the scope and range of equivalents of the claims. Like reference numbers and designations.

FIG. 1 is a block diagram illustrating a control system for a vehicle trunk, according to an exemplary embodiment of the present disclosure.

FIG. 2A and FIG. 2B are flowcharts illustrating a control method for a vehicle trunk, according to an exemplary embodiment of the present disclosure.

FIG. 3A and FIG. 3B are flowcharts illustrating a control method for a vehicle trunk, according to an exemplary embodiment of the present disclosure.

FIG. 4 is a flowchart illustrating a control method for a vehicle trunk, according to an exemplary embodiment of the present disclosure.

### DETAILED DESCRIPTION

Hereinafter, embodiments of the present disclosure will be described in detail with reference to the accompanying drawings. The present embodiments are implemented based on the technical solution of the present disclosure, and specific implementation methods and specific operation processes are shown, but the scope of protection of the present disclosure is not limited to the following embodiments. Components are schematically shown in the accompanying drawings for ease of description of the embodiments of the present disclosure and may be different from the forms actually implemented. In describing the embodiments with reference to the accompanying drawings, the same or corresponding components will be denoted by the same reference numerals and redundant description thereof will be omitted.

The terms such as first, second, A, B, (a), (b), and the like may be used herein to describe components. Each of these terminologies is not used to define an essence, order or sequence of a corresponding component but used merely to distinguish the corresponding component from other component(s). For example, a first component may be referred to a second component, and similarly the second component may also be referred to as the first component. The term “and/or” may include combinations of a plurality of related described items or any of a plurality of related described items.

Singular forms “a,” “an,” and “the” used in the specification and the appended claims are intended to include plural referents unless the context clearly dictates otherwise.

Some portions of the detailed descriptions which follow are presented in terms of procedures, logic blocks, processing, and other symbolic representations of operations on data within an electrical device. These descriptions and representations are the means used by those skilled in the data processing arts to most effectively convey the substance of their work to others skilled in the art. In the present application, a procedure, logic block, process, or the like, is conceived to be one or more self-consistent procedures or instructions leading to a desired result. The procedures are those requiring physical manipulations of physical quantities. Usually, although not necessarily, these quantities may take the form of electrical or magnetic signals capable of being stored, transferred, combined, compared, and otherwise manipulated in an electronic system, device, and/or component.

It should be borne in mind, however, that these and similar terms are to be associated with the appropriate physical quantities and are merely convenient labels applied to these quantities. Unless specifically stated otherwise as apparent from the following discussions, it is appreciated that throughout the description of embodiments, discussions utilizing terms such as “determining,” “communicating,” “taking,” “comparing,” “monitoring,” “calibrating,” “estimating,” “initiating,” “providing,” “receiving,” “controlling,” “transmitting,” “isolating,” “generating,” “aligning,” “synchronizing,” “identifying,” “maintaining,” “displaying,” “switching,” or the like, refer to the actions and processes of an electronic item such as: a processor, a sensor processing unit (SPU), a processor of a sensor processing unit, an application processor of an electronic device/system, or the like, or a combination thereof. The item manipulates and transforms data represented as physical (electronic and/or magnetic) quantities within the registers and memories into other data similarly represented as physical quantities within memories or registers or other such information storage, transmission, processing, or display components.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and may comprise hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles. In aspects, a vehicle may comprise an internal combustion engine system as disclosed herein.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Embodiments described herein may be discussed in the general context of processor-executable instructions residing on some form of non-transitory processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, logic, circuits, and steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example device vibration sensing system and/or electronic device described herein may comprise components other than those shown, including well-known components.

Various techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, perform one or more of the methods described herein. The non-transitory processor-readable data storage medium may form part of a computer program product, which may comprise packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

Various embodiments described herein may be executed by one or more processors, such as one or more motion processing units (MPUs), sensor processing units (SPUs), host processor(s) or core(s) thereof, digital signal processors (DSPs), general purpose microprocessors, application specific integrated circuits (ASICs), application specific instruction set processors (ASIPs), field programmable gate arrays (FPGAs), a programmable logic controller (PLC), a complex programmable logic device (CPLD), a discrete gate or transistor logic, discrete hardware components, or any combination thereof designed to perform the functions described herein, or other equivalent integrated or discrete logic circuitry. The term “processor,” as used herein may refer to any of the foregoing structures or any other structure suitable for implementation of the techniques described herein. As employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Moreover, processors can exploit nano-scale architectures such as, but not limited to, molecular and quantum-dot based transistors, switches and gates, in order to optimize space usage or enhance performance of user equipment. A processor may also be implemented as a combination of computing processing units.

In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any processor, controller, microcontroller, or state machine. A processor may also be implemented as a combination of computing devices, e.g., a combination of an SPU/MPU and a microprocessor, a plurality of microprocessors, one or more microprocessors in conjunction with an SPU core, MPU core, or any other such configuration. One or more components of an SPU or electronic device described herein may be embodied in the form of one or more of a “chip,” a “package,” an Integrated Circuit (IC).

Meanwhile, in the present disclosure, terms such as “first” and/or “second” may be used to describe various components, but the components are not limited by the terms. The terms are used only for the purpose of distinguishing one component from other components. For example, a first component may be referred to as a second component, and similarly, a second component may also be referred to as a first component without departing from the scope of rights according to the concept of the disclosed embodiment.

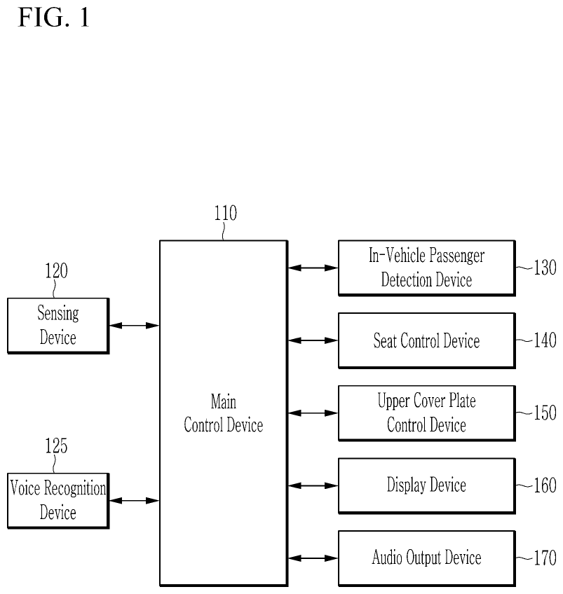

FIG. 1 is a block diagram illustrating a control system for a vehicle trunk, according to an exemplary embodiment of the present disclosure. As shown in FIG. 1, the control system for the vehicle trunk, according to the exemplary embodiment of the present disclosure, may comprise a main control device 110, a sensing device 120, an in-vehicle passenger detection device 130, a seat control device 140, and a trunk. The main control device 110 may be configured to be communicatively connected to the sensing device 120, the in-vehicle passenger detection device 130, and the seat control device 140, respectively.

The trunk provides a space for a user to store luggage or cargo, and a trunk volume is an index indicating a loading capacity of a vehicle trunk, generally expressed in units of liters (L). The trunk volume may comprise not only the capacity of the trunk in a normal state but also an expanded volume after folding a seat.

Most family or business vehicles may comprise a single-tier trunk and a two-tier trunk. The single-tier trunk refers to having only one independent storage area at the rear of the vehicle. Currently, some vehicle models are further equipped with a two-stage luggage board. That is, the trunk may comprise a lower cover plate and an upper cover plate, and correspondingly, a two-tier trunk refers to providing two independent storage areas, an upper storage area and a lower storage area, at the rear of the vehicle. A portion between the upper cover plate and a roof is an upper portion where small cargo can be placed. A portion between the lower cover plate and the upper cover plate is a lower portion where large cargo can be placed.

The sensing device 120 may be configured to detect a height of a user and a height and a volume of cargo carried by the user, and may be configured to transmit detected information to the main control device 110. The sensing device 120 may comprise a data collector and a processor, and the data collector may be configured to be communicatively connected to the processor.

The data collector may comprise a device such as a camera, LiDAR, or an ultrasonic radar, and the data collector may be configured to be mounted on a tailgate of the vehicle or may be configured to be mounted around the tailgate. The camera may be configured to be used to capture an image within a predetermined range around the vehicle. The LiDAR may be configured to generate high-precision three-dimensional point cloud data by emitting a laser beam and measuring a reflection time. The ultrasonic radar may be configured to measure a distance between an object and the vehicle by emitting ultrasonic waves and receiving reflected waves. Each data collector has advantages and applicable scenarios, and an appropriate device may be selected according to specific application requirements and technical requirements.

Correspondingly, the processor may be configured to process and analyze data collected by the data collector to extract relevant characteristic information, such as the height of the user and the height and the volume of the cargo carried by the user. For example, the processor may be configured to perform a comprehensive analysis based on information such as pixel distribution, brightness, and color of the captured image, and may be configured to calculate an approximate height of the user by analyzing a relative position and a proportional relationship of the user in the image, and may be configured to estimate the height and the volume of the cargo through analysis of a contour and a size of the cargo. The sensing device 120 according to the embodiment of the present disclosure is not limited to the above-described configuration and processing method.

The in-vehicle passenger detection device 130 may be configured to detect the number of passengers on a seat, determine a seating position in a situation where a passenger is present, and transmit detected information to the main control device 110.

Most family or business vehicles are equipped with a second-row seat or a third-row seat, and correspondingly, the in-vehicle passenger detection device 130 may be configured to detect the number of passengers on the second-row seat and/or the third-row seat, and may be configured to further determine a seating position, such as a left seat and/or a right seat of the second-row seat and/or the third-row seat. The in-vehicle passenger detection device 130 may comprise a sensor and a processor, and the sensor may be configured to be communicatively connected to the processor.

The sensor may comprise a weight sensor, an infrared sensor, or a camera. The weight sensor may be configured to sense pressure applied to the seat. The infrared sensor may be configured to be used to detect whether a passenger enters or exits the vehicle. The camera may be configured to be used to capture an image of an interior of the vehicle.

Correspondingly, the processor may be configured to receive a signal from the weight sensor and compare the received signal with a predetermined seat state to determine whether a passenger is present on the seat and a position of the passenger. The processor may be configured to determine a change in the number of passengers in the vehicle using a result detected by the infrared sensor. The processor may be configured to also determine the number of passengers and a specific position through image recognition technology according to an image captured by the camera. The in-vehicle passenger detection device 130 according to the embodiment of the present disclosure is not limited to the above-described configuration and processing method.

The seat control device 140 may be configured to receive a control signal from the main control device 110 to adjust a position, a height, a length, an angle, a backrest angle, and the like of the second-row seat and/or the third-row seat.

The main control device 110 may comprise a processor or a microprocessor (MCU). Optionally, the main control device 110 may further comprise a storage device. The above-described operations/functions of the main control device 110 may be configured to be implemented as computer-readable code/algorithm/software stored in a memory, and the memory may comprise a non-volatile computer-readable recording medium. The non-volatile computer-readable recording medium refers to any data storage device capable of storing data read by a processor or a microprocessor. For example, the computer-readable recording medium may comprise a Hard Disk Drive (HDD), a Solid State Disk (SSD), a Silicon Disk Drive (SDD), ROM, RAM, CD-ROM, a magnetic tape, a floppy disk, an optical data storage device, and the like. The processor or the microprocessor may be configured to execute the operations/functions of the main control device 110 by executing computer-readable code/algorithm/software stored in the non-volatile computer-readable recording medium.

According to an exemplary embodiment of the present disclosure, the communicative connection may comprise a connection through a wired communication and/or a wireless communication method. The wired communication method may comprise a Controller Area Network (CAN), a Local Interconnect Network (LIN), a Universal Serial Bus (USB), a High-definition Multimedia Interface (HDMI), a Digital Visual Interface (DVI), and the like. Here, the CAN may comprise a powertrain CAN bus (P_CAN), a body CAN bus (B_CAN), a chassis control CAN bus (C_CAN), and the like, but the CAN communication method is not limited to the above-described CAN bus communication methods. The wireless communication method may comprise Global System for Mobile Communications (GSM), Code Division Multiple Access (CDMA), Wideband Code Division Multiple Access (W-CDMA), Universal Mobile Telecommunications System (UMTS), Time Division Multiple Access (TDMA), Long Term Evolution (LTE), and the like.

According to an exemplary embodiment of the present disclosure, when a vehicle trunk is a single-tier, the main control device 110 may be configured to receive detection information from the sensing device 120 (that is, a height or a volume of cargo carried by a user) when a tailgate of the vehicle is in an openable state, and to adjust a seat of the vehicle based on the height or the volume of the cargo carried by the user.

The control system for the vehicle trunk according to the embodiment of the present disclosure may be configured to control operations of a second-row seat and/or a third-row seat through the height or the volume of the cargo carried by the user determined by the sensing device 120. When the user needs to load cargo having a relatively large volume, the system may be configured to secure more space and simplify operations by automatically folding the second-row seat and/or the third-row seat (that is, by causing a seatback of the second-row seat and/or the third-row seat to change from a substantially vertical state to a substantially horizontal state).

According to the embodiment of the present disclosure, when the vehicle trunk is a two-tier trunk, the control system for the vehicle trunk may further comprise an upper cover plate control device 150 of the trunk that may be configured to be communicatively connected to the main control device 110, receive a control signal from the main control device 110, and be configured to adjust a height of the upper cover plate of the trunk by moving the upper cover plate upward or downward. Correspondingly, the main control device 110 may be configured to receive detection information (that is, a height of the user, or the height or the volume of the cargo carried by the user) from the sensing device 120 when the tailgate of the vehicle is in the openable state, and to adjust the height of the upper cover plate and/or the vehicle seat by operating the upper cover plate control device 150 and the seat control device 140 based on the height of the user or the height or the volume of the cargo carried by the user.

According to the embodiment of the present disclosure, by determining the height of the user and adjusting the height of the upper cover plate according to the height of the user, the user may load cargo more comfortably and conveniently, and operations of the second-row seat and/or the third-row seat may be configured to be controlled according to the height or the volume of the cargo carried by the user.

The control system for the vehicle trunk according to the embodiment of the present disclosure may further comprise a voice recognition device 125 that may be configured to be communicatively connected to the main control device 110. The voice recognition device 125 may be configured to obtain a voice signal of the user, convert the voice signal of the user into a user request signal, and transmit the user request signal to the main control device 110.

The voice recognition device 125 may comprise a microphone and a processor. The microphone is used as an input device of the voice recognition device 125 and serves to capture the voice signal of the user. The microphone may be configured to be mounted at a position such as an outer side, an inner side, or a periphery of the tailgate of the vehicle, or a roof of the vehicle. The processor is configured to analyze and process the voice signal of the user to convert the voice signal into the user request signal, and to transmit the user request signal to the main control device 110 to control the vehicle seat. The user request signal may comprise information for causing the second-row seat and/or the third-row seat to be folded or returned to an original position, adjusting the height of the upper cover plate, and causing the upper cover plate to be folded or returned to an original position.

Correspondingly, the main control device 110 may be configured to receive a user request signal from the voice recognition device 125 when the tailgate of the vehicle is in an openable state, and to operate the upper cover plate control device 150 and/or the seat control device 140 according to the user request signal to adjust the upper cover plate and/or the vehicle seat.

According to the embodiment of the present disclosure, a voice control function is supported, and a user may control folding or moving of the second-row seat and/or the third-row seat, folding of the upper cover plate, and/or the height of the upper cover plate through only a simple voice command without using hands.

Whether the tailgate of the vehicle is in the openable state may be determined, for example, by detecting whether a vehicle key exists within a predetermined range of the vehicle. That is, when the vehicle key exists within the predetermined range of the vehicle, it may be determined that the tailgate of the vehicle is in the openable state. In addition, whether the tailgate is in the openable state may be determined through other suitable methods. For example, it is determined whether the tailgate is in the openable state by checking whether a mobile device exists within a setting range of the vehicle and determining whether the detected mobile device is authenticated. Embodiments of the present disclosure are not limited to the above-described determination method. Since a process of detecting whether the vehicle key or the mobile device exists within the predetermined range of the vehicle and a process of detecting whether the mobile device is authenticated are technologies known in the art, descriptions thereof will be omitted herein.

The control system for the vehicle trunk according to the embodiment of the present disclosure may further comprise a display device 160 (for example, a display) and an audio output device 170 (for example, a speaker). The display device 160 and the audio output device 170 may be configured to be communicatively connected to the main control device 110, respectively. When the vehicle is turned off (when the engine is turned off or the motor is turned off), the display device 160 may be configured to pop up a notification message informing the driver to take out cargo from the trunk, and the audio output device 170 may be configured to additionally output a warning sound to the driver.

The display device 160 may comprise, for example, a flat panel display device 160 such as a Liquid Crystal Display (LCD), an Organic Light Emitting Diode (OLED), or a Plasma Display Panel (PDP). According to an exemplary embodiment of the present disclosure, the display device 160 may be a part of an Audio Video Navigation Telecommunication (AVNT) device. The AVNT device may be configured to implement practical functions such as AI intelligent voice control, remote control, real-time mobile phone interconnection, and GPS navigation.

Hereinafter, a control method for a vehicle trunk according to an exemplary embodiment of the present disclosure will be described in detail with reference to specific embodiments.

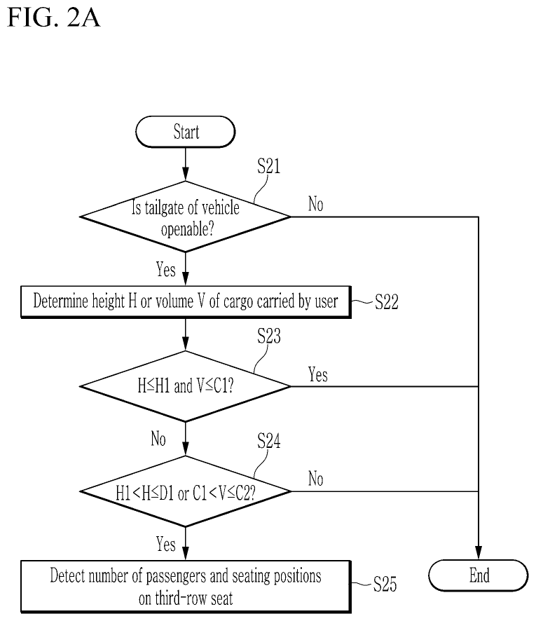

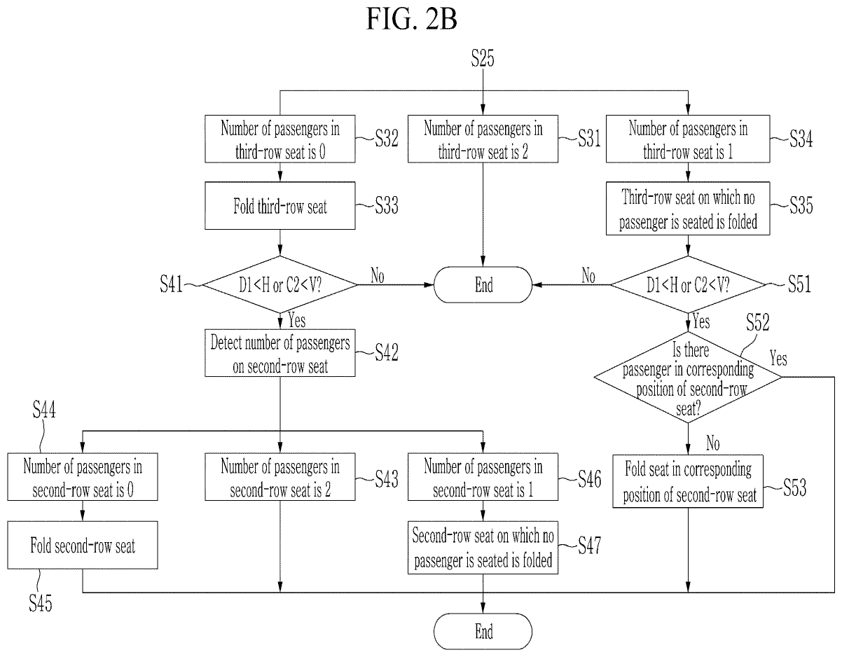

FIG. 2A and FIG. 2B are flowcharts illustrating a control method for a vehicle trunk according to an exemplary embodiment of the present disclosure.

According to an exemplary embodiment of the present disclosure, it is assumed that the vehicle includes a single-tier trunk and third-row seats. In this example, in a direction from the front to the rear of the vehicle, seats are sequentially referred to as first-row seats (that is, a driver seat and a passenger seat), second-row seats (that is, seats in a middle row), and third-row seats (that is, seats in a last row).

When the single-tier trunk is in a normal state (a state in which seats are not folded), a height of the trunk (that is, a height from a lower cover plate of the trunk to a roof of the vehicle) is expressed as a first height H1, and a capacity of the trunk is expressed as a first capacity C1. After the third-row seats of the vehicle (that is, the seats in the last row) are folded, a depth of the trunk is expressed as a first depth D1, and a capacity of the trunk (including the capacity C1 of the trunk and an expanded volume after the third-row seats are folded) is expressed as a second capacity C2. In general, the depth D1 of the trunk after folding the third-row seats of the vehicle is greater than the height H1 of the trunk.

Referring to FIG. 2A, in step S21, it is determined by the main control device 110 whether the tailgate of the vehicle is in the openable state.

When it is determined that the tailgate of the vehicle is in the openable state (that is, “YES” in step S21), in step S22, a height H or a volume V of cargo carried by the user is determined by the sensing device 120. By detecting the height H and the volume V of the cargo carried by the user, a loading space required for loading the cargo is determined.

In step S23, it is determined whether the height H of the cargo carried by the user is less than or equal to the height H1 of the trunk and whether the volume V of the cargo carried by the user is less than or equal to the capacity C1 of the trunk in the normal state.

When it is determined that the height H of the cargo carried by the user is less than or equal to the height H1 of the trunk and the volume V of the cargo carried by the user is less than or equal to the capacity C1 of the trunk in the normal state (that is, “YES” in step S23, that is, if H≤H1 and V≤C1), the seats are not adjusted.

When it is determined that the height H of the cargo carried by the user is less than or equal to the height H1 of the trunk or the volume V of the cargo carried by the user is less than or equal to the capacity C1 of the trunk in the normal state (that is, “NO” in step S23, if only one of the conditions H≤H1 and V≤C1 is satisfied), in step S24, it is determined by the main control device 110 whether the height H of the cargo carried by the user is greater than the height H1 of the trunk and less than or equal to the depth D1 of the trunk after folding the third-row seats, or whether the volume V of the cargo carried by the user is greater than the capacity C1 of the trunk in the normal state and less than or equal to the capacity C2 of the trunk after folding the third-row seats.

When it is determined that the height H of the cargo carried by the user is greater than the height H1 of the trunk and less than or equal to the depth D1 of the trunk after folding the third-row seats, or the volume V of the cargo carried by the user is greater than the capacity C1 of the trunk in the normal state and less than or equal to the capacity C2 of the trunk after folding the third-row seats (that is, “YES” in step S24, if one of the conditions H1 <H≤D1 and C1≤V≤C2 is satisfied), in step S25, the number of passengers and seating positions on the third-row seats are detected by the in-vehicle passenger detection device 130. By detecting the number of passengers on the seats, it is determined whether the seats need to be adjusted to provide more trunk space.

Referring further to FIG. 2B, as a result of the determination in step S25, when it is determined that the number of passengers on the third-row seats is two (step S31), the third-row seats are not folded.

When it is determined that the number of passengers on the third-row seats is zero (step S32), in step S33, a control signal for folding the third-row seats is generated by the main control device 110 and sent to the seat control device 140 to cause the third-row seats to be folded into a substantially horizontal state.

When it is determined that the number of passengers on the third-row seats is one (step S34), in step S35, a control signal for folding a seat on which a passenger is not seated (for example, a right third-row seat) among the third-row seats according to the seating position (for example, a left side of the third-row seats) is generated by the main control device 110 and sent to the seat control device 140 to cause the seat on which the passenger is not seated (for example, the right third-row seat) among the third-row seats to be folded.

Additionally, in a situation in which the third-row seats are folded, in step S41, it is determined by the main control device 110 whether the height H of the cargo carried by the user is greater than the depth D1 of the trunk after folding the third-row seats, or whether the volume V of the cargo carried by the user is greater than the capacity C2 of the trunk after folding the third-row seats.

When it is determined that the height H of the cargo carried by the user is greater than the depth D1 of the trunk after folding the third-row seats or the volume V of the cargo carried by the user is greater than the capacity C2 of the trunk after folding the third-row seats (that is, “YES” in step S41, if one of the conditions D1<H and C2<V is satisfied), in step S42, the number of passengers and seating positions on the second-row seats are detected by the in-vehicle passenger detection device 130.

Similar to the processing after detecting the number of passengers and the seating positions on the third-row seats, when it is determined that the number of passengers on the second-row seats is two (step S43), the second-row seats are not folded.

When it is determined that the number of passengers on the second-row seats is zero (step S44), in step S45, the main control device 110 generates a control signal for folding the second-row seats and transmits the control signal to the seat control device 140, so that the second-row seats are folded into a substantially horizontal state.

When it is determined that the number of passengers on the second-row seats is one (step S46), in step S47, the main control device 110 generates a control signal for folding the second-row seat where no passenger is seated (for example, a right-side second-row seat) according to a seating position (for example, a left-side of the second-row seats) and transmits the control signal to the seat control device 140, so that the second-row seat where no passenger is seated (for example, the right-side second-row seat) is folded.

Additionally, in a state in which a seat among the third-row seats where no passenger is seated has been folded, in step S51, the main control device 110 determines whether the height H of cargo carried by the user is greater than the depth D1 of the trunk after the folding of the third-row seat, or whether the volume V of the cargo carried by the user is greater than the capacity C2 of the trunk after the folding of the third-row seat.

When it is determined that the height H of the cargo carried by the user is greater than the depth D1 of the trunk after the folding of the third-row seat, or the volume V of the cargo carried by the user is greater than the capacity C2 of the trunk after the folding of the third-row seat (that is, “Yes” in step S51, if one of the conditions D1<H and C2<V is satisfied), in step S52, the in-vehicle passenger detection device 130 detects whether a passenger is present at a position in the second row (for example, the right side of the second-row seats) corresponding to the folded seat of the third row (for example, the right-side third-row seat).

When it is determined that no passenger is present at the position in the second row (for example, the right side of the second-row seats) corresponding to the folded seat of the third row (that is, “No” in step S52), in step S53, the seat at the position in the second row (the right-side second-row seat) corresponding to the folded seat of the third row (for example, the third row right seat) is folded.

When it is determined that there is a passenger in the position (right side of the second-row seat) corresponding to the folded seat of the third-row seat (for example, the right side of the third-row seat) among the second-row seats (that is, “Yes” in step S52), the second-row seats are not folded.

According to an exemplary embodiment of the present disclosure, operations of the second-row seats and/or the third-row seats are controlled based on the height or volume of the cargo carried by the user determined by the sensing device 120 and the detection results from the in-vehicle passenger detection device 130 to adapt to cargo of various sizes. When the user needs to load cargo having a relatively large volume, the system may be configured to automatically fold the second-row seats and/or the third-row seats to secure more space and simplify the operation process.

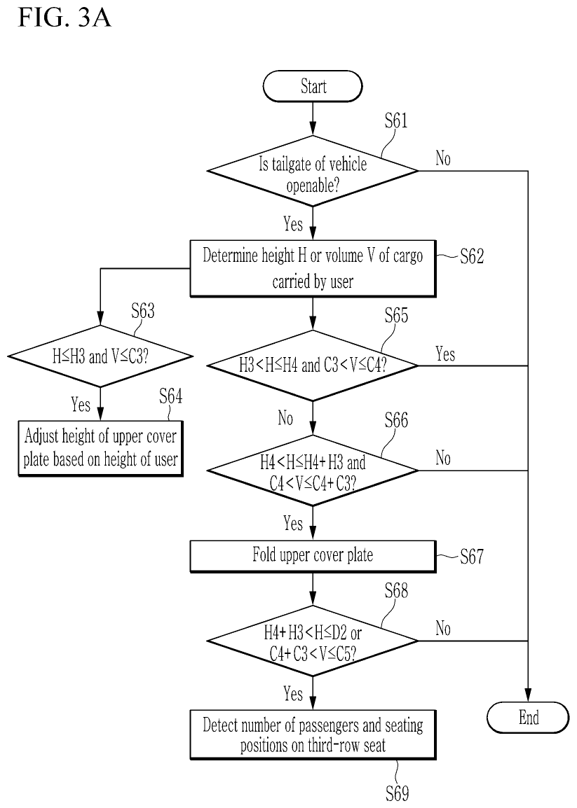

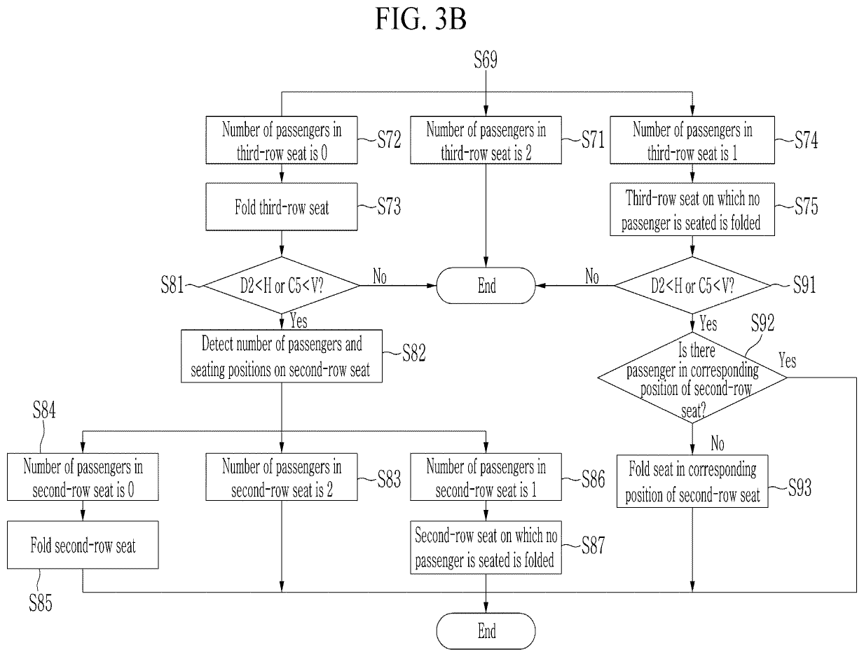

FIG. 3A and FIG. 3B are flowcharts illustrating a control method for a vehicle trunk according to an exemplary embodiment of the present disclosure.

According to an exemplary embodiment of the present disclosure, it is assumed that a vehicle includes a two-tier trunk and three rows seats. The two-tier trunk may comprise an upper portion and a lower portion, and the upper portion and the lower portion are separated by an upper cover plate. That is, a portion between the upper cover plate and a roof of the vehicle is the upper part, and a portion between the upper cover plate and a lower cover plate is the lower part. In a direction from the front to the rear of the vehicle, seats are sequentially referred to as first-row seats (that is, a driver seat and a passenger seat), second-row seats (middle-row seats), and third-row seats (that is, seats in a last row).

When the two-tier trunk is in a normal state (a state in which seats are not folded), a height of an upper portion of the trunk (that is, a height from the upper cover plate to the roof) is represented by a third height H3, and a height of a lower portion of the trunk (that is, a height from the lower cover plate to the upper cover plate) is represented by a fourth height H4. Generally, the fourth height H4 of the lower portion of the trunk is greater than the third height H3 of the upper portion of the trunk.

Correspondingly, a volume of the upper portion of the trunk is represented by a third capacity C3, and a volume of the lower portion of the trunk is represented by a fourth capacity C4, and after folding a third-row seat (that is, a last-row seat) of the vehicle, a depth of the trunk is represented by a second depth D2, and a capacity of the trunk (including the capacity C3 of the upper portion of the trunk, the capacity C4 of the lower portion of the trunk, and an expanded volume after folding the third-row seat) is represented by a fifth capacity C5. Generally, the capacity C3 of the upper portion of the trunk is smaller than the capacity C4 of the lower portion of the trunk, the second depth D2 is greater than a sum of the height H3 of the upper portion of the trunk and the height H4 of the lower portion of the trunk, and the expanded capacity C5 after folding the third-row seats is greater than the sum of the capacity C3 of the upper portion of the trunk and the capacity C4 of the lower portion of the trunk.

Referring to FIG. 3A, in step S61, it is determined by the main control device 110 whether the tailgate of the vehicle is in the openable state.

When it is determined that the tailgate of the vehicle is in the openable state (that is, “YES” in step S61), in step S62, a height H2 of a user, and a height H and a volume V of cargo carried by the user is determined by the sensing device 120.

In step S63, the main control device 110 determines whether the height H of the cargo carried by the user is less than or equal to the third height H3 of the upper portion and whether the volume V of the cargo carried by the user is less than or equal to the third capacity C3 of the upper portion of the trunk.

When it is determined that the height H of the cargo carried by the user is less than or equal to the height H3 of the upper portion of the trunk and the volume V of the cargo carried by the user is less than or equal to the capacity C3 of the upper portion of the trunk (that is, “Yes” in step S63, H≤H3 and V≤C3), then in step S64, the height of the upper cover plate is adjusted according to the height of the user by the main control device 110.

According to an exemplary embodiment of the present disclosure, the main control device 110 may be configured to determine an adjusted height of the upper cover plate through the following steps.

The adjusted height of the upper cover plate is determined according to a predetermined mapping table. The predetermined mapping table stores a correspondence relationship between the user's height and the adjusted height of the upper cover plate. When the height of the upper cover plate needs to be adjusted, the main control device 110 may be configured to retrieve the corresponding adjusted height in the mapping table according to the user's height. According to the retrieved adjusted height, the main control device 110 may be configured to transmit a control signal to the upper cover plate control device 150 to adjust the upper cover plate in a vertical direction.

According to an exemplary embodiment of the present disclosure, the upper cover plate may be configured to be adjusted to a predetermined height in the vertical direction based on a default height, and the predetermined height may be configured to be set within a range of ±(20 cm to 30 cm); however, embodiments of the present disclosure are not limited to the above range.

According to an exemplary embodiment of the present disclosure, when it is determined that the cargo carried by the user is suitable for placement in the upper portion of the trunk, the height of the upper cover plate is adjusted according to the height of the user, thereby allowing the user to load or unload the cargo more comfortably and conveniently.

Additionally, after adjusting the height of the upper cover plate to the predetermined height, the main control device 110 may be configured to cause the upper cover plate to be restored to the default height after a predetermined time elapses. According to an exemplary embodiment of the present disclosure, the predetermined time may be set to 30 seconds, 45 seconds, 60 seconds, or the like, but embodiments of the present disclosure are not limited to these values.

According to an exemplary embodiment of the present disclosure, the height of the upper cover plate of the trunk is automatically adjusted so that the user may smoothly load the cargo, and after the user loads the cargo into the trunk, the upper cover plate is automatically restored to the default state so that the user may continue to use the vehicle.

Returning to FIG. 3A, in step S65, the main control device 110 determines whether the height H of the cargo carried by the user is greater than the height H3 of the upper portion of the trunk and less than or equal to the height H4 of the lower portion of the trunk, and whether the volume V of the cargo carried by the user is greater than the capacity C3 of the upper portion of the trunk and less than or equal to the capacity C4 of the lower portion of the trunk.

When it is determined that the height H of the cargo carried by the user is greater than the height H3 of the upper portion of the trunk and less than or equal to the height H4 of the lower portion of the trunk, and that the volume V of the cargo carried by the user is greater than the capacity C3 of the upper portion of the trunk and less than or equal to the capacity C4 of the lower portion of the trunk (that is, “Yes” in step S65 and both conditions H3<H≤H4 and C3<V≤C4 are satisfied), the present disclosure does not adjust the upper cover plate and the seat. According to an exemplary embodiment of the present disclosure, when it is determined that the cargo carried by the user is suitable for placement in the lower portion of the trunk, the upper cover plate and the seat may not be adjusted.

When it is determined that the height H of the cargo carried by the user is greater than the height H3 of the upper portion of the trunk and less than or equal to the height H4 of the lower portion of the trunk, or the volume V of the cargo carried by the user is greater than the capacity C3 of the upper portion of the trunk and less than or equal to the capacity C4 of the lower portion of the trunk (that is, “No” in step S65, if one of the conditions of H3<H≤H4 and C3<V≤C4 is satisfied), in step S66, the main control device 110 determines whether the height H of the cargo carried by the user is greater than the height H4 of the lower portion of the trunk and less than or equal to the sum (H4+H3) of the height (H4) of the lower portion of the trunk and the height H3 of the upper portion of the trunk, and whether whether the volume V of the cargo carried by the user is greater than the capacity C4 of the lower portion of the trunk and less than or equal to the sum (C3+C4) of the capacity C3 of the upper portion of the trunk and the capacity C4 of the lower portion of the trunk.

When it is determined that the height H of the cargo carried by the user is greater than the height H4 of the lower portion of the trunk and less than or equal to the sum (H4+H3) of the height H4 of the lower portion of the trunk and the height H3 of the upper portion of the trunk, and the volume V of the cargo carried by the user is greater than the capacity C4 of the lower portion of the trunk and less than or equal to the sum (C3+C4) of the capacity C3 of the upper portion of the trunk and the capacity C4 of the lower portion of the trunk (that is, “YES” in step S66, satisfying both conditions H4 <H ≤H4+H3 and C4 <V≤C3+C4), the upper cover plate is folded by the main control device 110 in step S67 (that is, the upper cover plate is changed from a substantially horizontal state to a substantially vertical state or a state of being in close contact with the third-row seat).

Returning to FIG. 3A, in step S68, the main control device 110 determines whether the height H of the cargo carried by the user is greater than the sum (H4+H3) of the height H4 of the lower portion of the trunk and the height H3 of the upper portion of the trunk and less than or equal to the depth D2 of the trunk after folding the third-row seat, or whether the volume V of the cargo carried by the user is greater than the sum (C3+C4) of the capacity C3 of the upper portion of the trunk and the capacity C4 of the lower portion of the trunk and less than or equal to the capacity C5 of the trunk after folding the third-row seat of the vehicle.

When it is determined that the height H of the cargo carried by the user is greater than the sum (H4+H3) of the height H4 of the lower portion of the trunk and the height H3 of the upper portion of the trunk and less than or equal to the depth D2 of the trunk after folding the third-row seat, or the volume V of the cargo carried by the user is greater than the sum (C3+C4) of the capacity C3 of the upper portion of the trunk and the capacity C4 of the lower portion of the trunk and less than or equal to the capacity C5 of the trunk after folding the third-row seat of the vehicle (that is, “YES” in step S68, satisfying one of the conditions H4+H3<H ≤D2 and C4+C3 <V≤C5), the in-vehicle passenger detection device 130 detects the number of passengers and seating positions on the third-row seat in step S69.

Referring further to FIG. 3B, as a result of the determination in step S69, when it is determined that the number of passengers on the third-row seats is two (step S71), the third-row seats are not folded.

When it is determined that the number of passengers on the third-row seat is zero (step S72), in step S73, the main control device 110 generates a control signal for folding the third-row seat and transmits the control signal to the seat control device 140 to fold the third-row seat.

When it is determined that the number of passengers on the third-row seats is one (step S74), in step S75, a control signal for folding a seat on which a passenger is not seated (for example, a right third-row seat) among the third-row seats according to the seating position (for example, a left side of the third-row seats) is generated by the main control device 110 and sent to the seat control device 140 to cause the seat on which the passenger is not seated (for example, the right third-row seat) among the third-row seats to be folded.

Additionally, in a situation in which the third-row seats are folded, in step S81, it is determined by the main control device 110 whether the height H of the cargo carried by the user is greater than the depth D2 of the trunk after folding the third-row seats, or whether the volume V of the cargo carried by the user is greater than the capacity C5 of the trunk after folding the third-row seats of the vehicle.

When it is determined that the height H of the cargo carried by the user is greater than the depth D2 of the trunk after folding the third-row seats or the volume V of the cargo carried by the user is greater than the capacity C5 of the trunk after folding the third-row seats of the vehicle (that is, “YES” in step S41, satisfying one of the conditions D1<H and C2<V), in step S82, the number of passengers and seating positions on the second-row seats are detected by the in-vehicle passenger detection device 130.

Similar to the processing after detecting the number of passengers and the seating positions on the third-row seats, when it is determined that the number of passengers on the second-row seats is two (step S83), the second-row seats are not folded.

When it is determined that the number of passengers on the second-row seat is zero (step S84), in step S85, the main control device 110 generates a control signal for folding the second-row seat and transmits the control signal to the seat control device 140 to fold the second-row seat.

When it is determined that the number of passengers on the second-row seats is one (step S86), in step S87, the main control device 110 generates a control signal for folding the second-row seat where no passenger is seated (for example, a right-side second-row seat) according to a seating position (for example, a left-side of the second-row seats) and transmits the control signal to the seat control device 140, so that the second-row seat where no passenger is seated (for example, the right-side second-row seat) is folded.

Returning to step S75, in a state in which a seat among the third-row seats where no passenger is seated has been folded, in step S91, the main control device 110 determines whether the height H of cargo carried by the user is greater than the depth D2 of the trunk after the folding of the third-row seat, or whether the volume V of the cargo carried by the user is greater than the capacity C2 of the trunk after the folding of the third-row seat of the vehicle.

When it is determined that the height H of the cargo carried by the user is greater than the depth D2 of the trunk after the folding of the third-row seat, or the volume V of the cargo carried by the user is greater than the capacity C5 of the trunk after the folding of the third-row seat of the vehicle (that is, “Yes” in step S91, satisfying one of the conditions D1<H and C2<V), in step S92, the in-vehicle passenger detection device 130 detects whether a passenger is present at a position in the second row (for example, the right side of the second-row seats) corresponding to the folded seat of the third row (for example, the right-side third-row seat).

When it is determined that no passenger is present at the position in the second row (for example, the right side of the second-row seats) corresponding to the folded seat of the third row (that is, “No” in step S92), in step S93, the seat at the position in the second row (the right-side second-row seat) corresponding to the folded seat of the third row (for example, the third row right seat) is folded.

When it is determined that there is a passenger in the position (right side of the second-row seat) corresponding to the folded seat of the third-row seat (for example, the right side of the third-row seat) among the second-row seats (that is, “Yes” in step S92), the second-row seats are not folded.

According to an exemplary embodiment of the present disclosure, when a user needs to load cargo having a relatively large volume, operations of the second-row seat and/or the third-row seat are controlled based on the height or volume of the cargo carried by the user and the detected result by the in-vehicle passenger detection device 130, thereby enabling adaptation to cargo of various sizes.

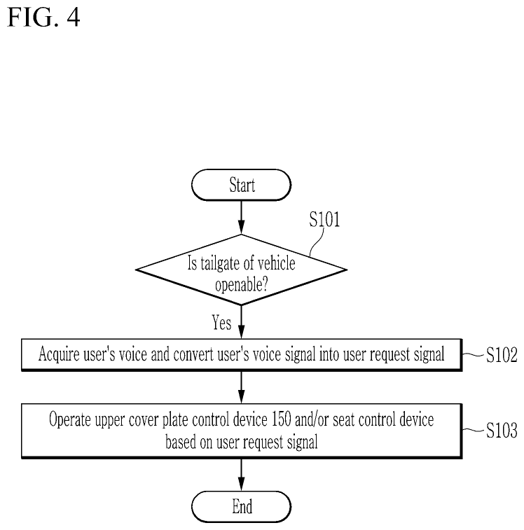

FIG. 4 is a flowchart illustrating a control method for a vehicle trunk according to another embodiment of the present disclosure.

The control method for the vehicle trunk according to the embodiment of the present disclosure may be configured to support a voice control function, and a user may control folding or restoring the second-row seat and/or the third-row seat, folding or restoring the upper cover plate, and/or a height of the upper cover plate with a simple command.

Referring to FIG. 4, in step S101, the main control device 110 determines whether a tailgate of the vehicle is in an openable state.

When it is determined in step S102 that the tailgate of the vehicle is in an openable state, the voice recognition device 125 acquires a user's voice, converts a voice signal of the user into a user request signal, and transmits the user request signal to the main control device 110.

In step S103, the main control device 110 receives the user request signal from the voice recognition device 125 and causes the upper cover plate control device 150 and/or the seat control device 140 to operate according to the user request signal, thereby folding or restoring the second-row seat and/or the third-row seat, adjusting the height of the upper cover plate, and folding or restoring the upper cover plate.

Similar to the process of controlling the folding or restoration of seats through voice, the control method for the vehicle trunk according to the embodiment of the present disclosure may be configured to also adjust the height of the trunk upper cover plate and fold or restore the upper cover plate through voice.

According to the embodiments of the present disclosure, in addition to freeing the user's hands, the user may control the folding or restoration of the seat through voice, and/or adjust the height of the upper cover plate of the trunk.

The various embodiments of the present disclosure are not intended to be an exhaustive list of all possible combinations but are intended to describe representative aspects of the present disclosure, and the details described in the various embodiments may be applied independently or in a combination of two or more.

While this disclosure has been described in connection with what is presently considered to be practical embodiments, it is to be understood that the disclosure is not limited to the disclosed embodiments. On the contrary, it is intended to cover various modifications and equivalent arrangements included within the spirit and scope of the appended claims.

The embodiments of the present disclosure have been described in detail above, and the terms or words used in this specification and claims shall not be construed as being limited to typical or dictionary meanings. In addition, since the embodiments described in this specification and the configurations shown in the drawings are only embodiments of the present disclosure, the scope of the present disclosure is not limited to the above-described embodiments. Various modifications and improvements made by those skilled in the art using the basic concept of the present disclosure defined in the following claims also fall within the scope of the present disclosure.

What is claimed is:

1. A control system for a vehicle trunk, comprising:
a sensing device configured to detect a height or a volume of a cargo carried by a user;
a seat control device configured to fold a second-row seat and/or a third-row seat; and
a main control device communicatively connected to the sensing device and the seat control device, respectively,
wherein the main control device is configured to:
receive the height or the volume of the cargo from the sensing device when a tailgate of a vehicle is in an openable state; and
operate the seat control device based on the height or the volume of the cargo.

2. The control system for the vehicle trunk of claim 1, further comprising an in-vehicle passenger detection device communicatively connected to the main control device and configured to detect a number of passengers and a seating position on the second-row seat and/or the third-row seat,
wherein the main control device is further configured to:
determine:
whether the height of the cargo is less than or equal to a height of the trunk;
and
whether the volume of the cargo is less than or equal to a capacity of the trunk in a normal state;
determine, when it is determined that the height of the cargo is less than or equal to the height of the trunk or the volume of the cargo is less than or equal to the capacity of the trunk in the normal state:
whether the height of the cargo is greater than the height of the trunk and less than or equal to a depth of the trunk after folding of the third-row seat; or
whether the volume of the cargo is greater than the capacity of the trunk in the normal state and less than or equal to the capacity of the trunk after folding of the third-row seat;
obtain the number of passengers and the seating position on the third-row seat when it is determined:
that the height of the cargo is greater than the height of the trunk and less than or equal to the depth of the trunk after folding of the third-row seat; or
that the volume of the cargo is greater than the capacity of the trunk in the normal state and less than or equal to the capacity of the trunk after folding of the third-row seat; and
fold a seat, among the third-row seats, on which a passenger is not seated according to the seating position on the third-row seat.

3. The control system for the vehicle trunk of claim 1, further comprising an upper cover plate control device communicatively connected to the main control device and configured to adjust a height of an upper cover plate,
wherein:
the sensing device is further configured to detect a height of the user, and
the main control device is further configured to:
determine whether the height of the cargo is less than or equal to a height of an upper portion of the trunk and whether the volume of the cargo is less than or equal to a capacity of the upper portion of the trunk; and
adjust the height of the upper cover plate according to the height of the user when it is determined that:
the height of the cargo is less than or equal to the height of the upper portion of the trunk; and
the volume of the cargo is less than or equal to the capacity of the upper portion of the trunk.

4. The control system for the vehicle trunk of claim 3, wherein:
the main control device is further configured to:
retrieve a corresponding adjustment height of the upper cover plate according to the height of the user in a predetermined mapping table;
adjust the height of the upper cover plate to a sum of a basic height and the adjustment height according to the retrieved adjustment height of the upper cover plate;
and
restore the upper cover plate to the basic height after a predetermined period of time has elapsed, and
the predetermined mapping table stores a correspondence relationship between the height of the user and the adjustment height of the upper cover plate.

5. The control system for the vehicle trunk of claim 1, further comprising an upper cover plate control device communicatively connected to the main control device and configured to fold an upper cover plate,
wherein the main control device is further configured to:
determine:
whether the height of the cargo is greater than a height of an upper portion of the trunk and less than or equal to a height of a lower portion of the trunk; and
whether the volume of the cargo is greater than a capacity of the upper portion of the trunk and less than or equal to a capacity of the lower portion of the trunk;
determine, when it is determined that the height of the cargo is greater than the height of the upper portion of the trunk and less than or equal to the height of the lower portion of the trunk, or that the volume of the cargo is greater than the capacity of the upper portion of the trunk and less than or equal to the capacity of the lower portion of the trunk:
whether the height of the cargo is greater than the height of the lower portion of the trunk and less than or equal to a sum of the height of the lower portion and the height of the upper portion of the trunk; and
whether the volume of the cargo is greater than the capacity of the lower portion of the trunk and less than or equal to a sum of the capacity of the upper portion and the capacity of the lower portion of the trunk; and
fold the upper cover plate when it is determined:
that the height of the cargo is greater than the height of the lower portion of the trunk and less than or equal to the sum of the height of the lower portion and the height of the upper portion of the trunk; or
that the volume of the cargo is greater than the capacity of the lower portion of the trunk and less than or equal to the sum of the capacity of the upper portion and the capacity of the lower portion of the trunk.

6. The control system for the vehicle trunk of claim 5, further comprising an in-vehicle passenger detection device communicatively connected to the main control device and configured to detect a number of passengers and a seating position on the second-row seat and/or the third-row seat,
wherein the main control device is further configured to:
determine:
whether the height of the cargo is greater than the sum of the height of the lower portion and the height of the upper portion of the trunk and less than or equal to a depth of the trunk after folding of the third-row seat; or
whether the volume of the cargo is greater than the sum of the capacity of the upper portion and the capacity of the lower portion of the trunk and less than or equal to a capacity of the trunk after folding of the third-row seat;
obtain the number of passengers and the seating position on the third-row seat when it is determined:
that the height of the cargo is greater than the sum of the height of the lower portion and the height of the upper portion of the trunk and less than or equal to the depth of the trunk after folding of the third-row seat; or
that the volume of the cargo is greater than the sum of the capacity of the upper portion and the capacity of the lower portion of the trunk and less than or equal to the capacity of the trunk after folding of the third-row seat; and
fold a seat, among the third-row seats, on which a passenger is not seated according to the seating position on the third-row seat.

7. The control system for the vehicle trunk of claim 2, wherein the main control device is further configured to, in a state in which all third-row seats are folded:
determine whether the height of the cargo is greater than the depth of the trunk after folding of the third-row seat, or whether the volume of the cargo is greater than the capacity of the trunk after folding of the third-row seat;
obtain the number of passengers and a seating position on the second-row seat when it is determined:
that the height of the cargo is greater than the depth of the trunk after folding of the third-row seat; or
that the volume of the cargo is greater than the capacity of the trunk after folding of the third-row seat; and
fold a second-row seat on which a passenger is not seated according to the seating position on the second-row seat.

8. The control system for the vehicle trunk of claim 2, wherein the main control device is further configured to, in a state in which the seat among the third-row seats on which a passenger is not seated is folded:
determine:
whether the height of the cargo is greater than the depth of the trunk after folding of the third-row seat; or
whether the volume of the cargo is greater than the capacity of the trunk after folding of the third-row seat;
determine, when it is determined that the height of the cargo is greater than the depth of the trunk after folding of the third-row seat, or that the volume of the cargo carried is greater than the capacity of the trunk after folding of the third-row seat, whether a passenger is present at a position in the second-row seat corresponding to the folded seat of the third-row seat; and
fold a seat at the position in the second-row seat corresponding to the folded seat of the third-row seat when it is determined that no passenger is present at the position in the second-row seat corresponding to the folded seat of the third-row seat.

9. The control system for the vehicle trunk of claim 1, further comprising:
a voice recognition device communicatively connected to the main control device and configured to:
obtain a voice signal of the user;
convert the voice signal of the user into a user request signal; and
transmit the user request signal to the main control device; and
an upper cover plate control device communicatively connected to the main control device and configured to adjust a height of an upper cover plate,
wherein the main control device is further configured to:
receive the user request signal from the voice recognition device when it is determined that the tailgate of the vehicle is in an openable state;
operate the upper cover plate control device and/or the seat control device according to the user request signal to adjust a height of the upper cover plate;
fold the upper cover plate, and
fold the second-row seat and/or the third-row seat.

10. The control system for the vehicle trunk of claim 1, further comprising a display device and an audio output device communicatively connected respectively to the main control device,
wherein:
the display device is configured to pop up a notification message prompting the user to take out the cargo from the trunk when an ignition of the vehicle is turned off; or
the audio output device is configured to output a warning sound prompting the user to take out the cargo from the trunk when the vehicle is turned off.

11. A control method for a vehicle trunk, comprising:
detecting, by a sensing device, a height or a volume of a cargo carried by a user;
obtaining, by a main control device, the height or the volume of the cargo when a tailgate of a vehicle is in an openable state; and
controlling, by a seat control device, a second-row seat and/or a third-row seat to be folded based on the obtained height or the obtained volume.

12. The control method for the vehicle trunk of claim 11, further comprising:
determining:
whether the height of the cargo is less than or equal to a height of the trunk; and
whether the volume of the cargo is less than or equal to a capacity of the trunk in a normal state;
determining, when it is determined that the height of the cargo is less than or equal to the height of the trunk or the volume of the cargo is less than or equal to the capacity of the trunk in the normal state:
whether the height of the cargo is greater than the height of the trunk and less than or equal to a depth of the trunk after folding of the third-row seat; or
whether the volume of the cargo is greater than the capacity of the trunk in the normal state and less than or equal to the capacity of the trunk after folding of the third-row seat;
detecting, by an in-vehicle passenger detection device, a number of passengers and a seating position on the third-row seat when it is determined:
that the height of the cargo is greater than the height of the trunk and less than or equal to the depth of the trunk after folding of the third-row seat; or
that the volume of the cargo is greater than the capacity of the trunk in the normal state and less than or equal to the capacity of the trunk after folding of the third-row seat;
and
folding a seat, among the third-row seats, on which a passenger is not seated according to the seating position on the third-row seat.

13. The control method for the vehicle trunk of claim 11, further comprising:
detecting, by the sensing device, a height of the user;
determining, by the main control device:
whether the height of the cargo is less than or equal to a height of an upper portion of the trunk; and
whether the volume of the cargo is less than or equal to a capacity of the upper portion of the trunk; and
adjusting, by the main control device, the height of the upper cover plate according to the height of the user when it is determined that the height of the cargo is less than or equal to the height of the upper portion of the trunk and the volume of the cargo is less than or equal to the capacity of the upper portion of the trunk.

14. The control method for the vehicle trunk of claim 13, further comprising:
retrieving a corresponding adjustment height of the upper cover plate according to the height of the user in a predetermined mapping table;
adjusting the height of the upper cover plate to a sum of a basic height and the adjustment height according to the retrieved adjustment height of the upper cover plate; and
restoring the upper cover plate to the basic height after a predetermined period of time has elapsed,
wherein the predetermined mapping table stores a correspondence relationship between the height of the user and the adjustment height of the upper cover plate.

15. The control method for the vehicle trunk of claim 11, further comprising:
determining, by the main control device:
whether the height of the cargo is greater than a height of an upper portion of the trunk and less than or equal to a height of a lower portion of the trunk; and
whether the volume of the cargo is greater than a capacity of the upper portion of the trunk and less than or equal to a capacity of the lower portion of the trunk;
determining, by the main control device, when it is determined that the height of the cargo is greater than the height of the upper portion of the trunk and less than or equal to the height of the lower portion of the trunk, or that the volume of the cargo is greater than the capacity of the upper portion of the trunk and less than or equal to the capacity of the lower portion of the trunk:
whether the height of the cargo is greater than the height of the lower portion of the trunk and less than or equal to a sum of the height of the lower portion and the height of the upper portion of the trunk; and
whether the volume of the cargo is greater than the capacity of the lower portion of the trunk and less than or equal to a sum of the capacity of the upper portion and the capacity of the lower portion of the trunk; and
folding, by an upper cover plate control device, the upper cover plate when it is determined:
that the height of the cargo is greater than the height of the lower portion of the trunk and less than or equal to the sum of the height of the lower portion and the height of the upper portion of the trunk; or
that the volume of the cargo is greater than the capacity of the lower portion of the trunk and less than or equal to the sum of the capacity of the upper portion and the capacity of the lower portion of the trunk.

16. The control method for the vehicle trunk of claim 15, further comprising:
determining, by the main control device,:
whether the height of the cargo is greater than the sum of the height of the lower portion and the height of the upper portion of the trunk and less than or equal to a depth of the trunk after folding of the third-row seat; or
whether the volume of the cargo is greater than the sum of the capacity of the upper portion and the capacity of the lower portion of the trunk and less than or equal to a capacity of the trunk after folding of the third-row seat;
detecting, by an in-vehicle passenger detection device, a number of passengers and a seating position on the third-row seat when it is determined:
that the height of the cargo is greater than the sum of the height of the lower portion and the height of the upper portion of the trunk and less than or equal to the depth of the trunk after folding of the third-row seat; or
that the volume of the cargo is greater than the sum of the capacity of the upper portion and the capacity of the lower portion of the trunk and less than or equal to the capacity of the trunk after folding of the third-row seat; and
folding a seat, among the third-row seats, on which a passenger is not seated according to the seating position on the third-row seat.

17. The control method for the vehicle trunk of claim 12, further comprising, in a state in which all third-row seats are folded:
determining:
whether the height of the cargo is greater than the depth of the trunk after folding of the third-row seat; or
whether the volume of the cargo is greater than the capacity of the trunk after folding of the third-row seat;
detecting, by an in-vehicle passenger detection device, a number of passengers and a seating position on the second-row seat when it is determined:
that the height of the cargo is greater than the depth of the trunk after folding of the third-row seat; or
that the volume of the cargo is greater than the capacity of the trunk after folding of the third-row seat; and
folding a second-row seat on which a passenger is not seated according to the seating position on the second-row seat.

18. The control method for the vehicle trunk of claim 12, further comprising, in a state in which the seat among the third-row seats on which a passenger is not seated is folded:
determining:
whether the height of the cargo is greater than the depth of the trunk after folding of the third-row seat; or
whether the volume of the cargo is greater than the capacity of the trunk after folding of the third-row seat;
determining, when it is determined that the height of the cargo is greater than the depth of the trunk after folding of the third-row seat, or that the volume of the cargo carried is greater than the capacity of the trunk after folding of the third-row seat, whether a passenger is present at a position in the second-row seat corresponding to the folded seat of the third-row seat; and
folding a seat at the position in the second-row seat corresponding to the folded seat of the third-row seat when it is determined that no passenger is present at the position in the second-row seat corresponding to the folded seat of the third-row seat.

19. The control method for the vehicle trunk of claim 11, further comprising:
obtaining, by a voice recognition device, a voice signal of the user and converting the voice signal of the user into a user request signal;
obtaining, by the main control device, the user request signal when it is determined that the tailgate of the vehicle is in an openable state;
operating an upper cover plate control device and/or the seat control device according to the user request signal to adjust a height of the upper cover plate, folding the upper cover plate; and
folding the second-row seat and/or the third-row seat.

20. The control method for the vehicle trunk of claim 11, further comprising:
popping up, by a display device, a notification message prompting the user to take out the cargo from the trunk when an ignition of the vehicle is turned off; or
outputting, by an audio output device, a warning sound prompting the user to take out the cargo from the trunk when the ignition of the vehicle is turned off.
